(19) United States
(12) Patent Application Publication
(10) Pub. No.: US 2026/0018162 A1
(43) Pub. Date: Jan. 15, 2026

(54) METHOD, DEVICE AND PROGRAM FOR LEARNING ARTIFICIAL NEURAL NETWORKS BASED ON SPEECH IMAGINATION BIOSIGNALS AND PHONEME INFORMATION

(71) Applicant: Korea University Research and Business Foundation, Seoul (KR)

(72) Inventors: Seong Whan LEE, Seoul (KR); Deok Seon KIM, Incheon (KR); Seo Hyun LEE, Seoul (KR)

(21) Appl. No.: 18/981,333

(22) Filed: Dec. 13, 2024

(30) Foreign Application Priority Data
Jul. 11, 2024 (KR) 10-2024-0091878

(51) Int. Cl. G10L 15/06; G10L 15/02; G10L 15/16

(52) U.S. Cl. CPC G10L 15/063; G10L 15/02; G10L 15/16; G10L 2015/025

(57) ABSTRACT

A method for learning an artificial neural network based on speech imagination biosignals and phoneme information according to one embodiment of the present disclosure may comprise the steps of collecting speech imagination biosignals; labeling the collected speech imagination biosignals with phoneme information; pre-processing the labeled speech imagination biosignals; extracting feature vectors of the pre-processed speech imagination biosignals; and learning the extracted feature vectors through an artificial neural network to generate a classification model, wherein the pre-processing includes windowing to cut the labeled speech imagination biosignals in phoneme units, and the learning includes labeling a phoneme information for the feature vectors extracted in phoneme units.

### CROSS-REFERENCE TO RELATED APPLICATION

This application claims priority under 35 U.S.C § 119 to Korean Patent Application No. 10-2024-0091878 filed in the Korean Intellectual Property Office on Jul. 11, 2024, the entire contents of which are hereby incorporated by reference.

### FIELD OF THE DISCLOSURE

The present disclosure relates to a method, device and program for learning artificial neural networks based on speech imagination biosignals and phoneme information. Specifically, the present disclosure relates to a method, device and program for learning biosignals, which are generated based on a user's speech imagination, in phoneme units.

This work was partly supported by Institute of Information & Communications Technology Planning & Evaluation (IITP) grant funded by the Korea government (MSIT) (No. RS-2021-II-212068, Artificial Intelligence Innovation Hub, No. RS-2024-00336673, AI Technology for Interactive Communication of Language Impaired Individuals, and No. RS-2019-II190079, Artificial Intelligence Graduate School Program (Korea University)).
[Research and Development Number] RS-2021-II-212068
[Ministry] MSIT (Ministry of Science and ICT)
[Research Management Institution] IITP (Institute for Information & communication Technology Planning & Evaluation)
[Research Project Title] Artificial Intelligence Innovation Hub
[Research Institution] Korea University
[Research Period] Jul. 1, 2021˜December 31.
[Research and Development Number] No. RS-2024-00336673
[Ministry] MSIT (Ministry of Science and ICT)
[Research Management Institution] IITP (Institute for Information & communication Technology Planning & Evaluation)
[Research Project Title] AI Technology for Interactive Communication of Language Impaired Individuals
[Research Institution] Korea University
[Research Period] Apr. 1, 2024˜Dec. 31, 2026.
[Research and Development Number] No. RS-2019-II190079
[Ministry] MSIT (Ministry of Science and ICT)
[Research Management Institution] IITP (Institute for Information & communication Technology Planning & Evaluation)
[Research Project Title] Artificial Intelligence Graduate School Program (Korea University)
[Research Institution] Korea University
[Research Period] Apr. 1, 2019˜Dec. 31, 2028.

### BACKGROUND

Examples of biosignals include an electromyography (EMG), an electroencephalography (EEG) and the like. The electromyography can noninvasively measure electrical activities between nerve cells in the brain and precisely grasp various signals of the brain.

Recently, technologies that utilize brainwaves have expanded to the field of brain-computer interface (BCI), making remarkable progress. The brain-computer interface, which is a technology that can directly transmit the user's intention or thoughts to a computer system, is utilized to provide functions such as message transmission, environment control and voice synthesis, especially for people with limited movement or communication.

A phoneme, which is the most basic unit of speech, is the smallest unit (e.g., /p/, /a/, /s/, etc.) of sound recognized by language users that is distinguished from other sounds in the sound system of language and plays an opposing function. Various words or sentences are formed by combining phonemes.

Text-to-speech (TTS) refers to a technology that converts text information into audio signals similar to human voice. In the early stages of TTS technology, mechanical and unnatural voice output was common, but thanks to recent research and technological advancements, the TTS system can convert the text into very natural and understandable voice. Recently, the TTS technology is rapidly developing due to the advent of a deep learning and artificial neural networks, and in particular, models based on recurrent neural networks (RNNs) and transformer architectures are attracting attention.

### SUMMARY

The present disclosure proposes a technique for learning artificial neural networks by considering phoneme information from biosignals. Specifically, the present disclosure proposes a multilingual communication system that analyzes the biosignals during a user's speech imagination, recognizes and learns phoneme information contained in words or sentences, etc. without distinguishing languages, thereby enabling conversion between different languages. The converted vector that has gone through the translation process is finally provided to the user in the form of voice audio, and at this time, a pre-learned TTS model can be used.

The present disclosure proposes a multilingual communication method and system that synthesizes reconstructed words or sentences, etc. into voices and enables silent conversation only by imagination without actually speaking.

Meanwhile, the technical challenges of the present disclosure are not limited to those mentioned above, and other challenges that are not mentioned can be clearly understood by those skilled in the art from the description below.

A method for learning an artificial neural network based on speech imagination biosignals and phoneme information according to one embodiment of the present disclosure may comprise the steps of: collecting speech imagination biosignals; labeling the collected speech imagination biosignals with phoneme information; pre-processing the labeled speech imagination biosignals; extracting feature vectors of the pre-processed speech imagination biosignals; and learning the extracted feature vectors through an artificial neural network to generate a classification model, wherein the pre-processing includes windowing to cut the labeled speech imagination biosignals in phoneme units, and the learning includes labeling a phoneme information for the feature vectors extracted in phoneme units.

The method may further comprise the steps of: collecting target speech imagination biosignals; pre-processing the collected target speech imagination biosignals; extracting feature vectors of the pre-processed target speech imagination biosignals; obtaining a phoneme sequence vector from the feature vectors of the extracted target speech imagination biosignals through the classification model; and obtaining an audio signal from the phoneme sequence vector through a text-to-speech model.

The speech imagination biosignals may be an electroencephalogram. The method may further include the step of storing the speech imagination biosignals. The pre-processing may further include frequency-filtering the labeled speech imagination biosignals. The windowing may be performed so that adjacent windows at least partially overlap each other. The learning may be performed for one or more languages.

A device for learning an artificial neural network based on speech imagination biosignals and phoneme information according to one embodiment of the disclosure may comprise a biosignal collection unit for collecting speech imagination biosignals; a phoneme information labeling unit for labelling the collected speech imagination biosignals with phoneme information; a signal pre-processing unit for pre-processing the labeled speech imagination biosignals; a feature vector extraction unit for extracting feature vectors of the pre-processed speech imagination biosignals; and an artificial neural network learning unit for learning the extracted feature vectors through an artificial neural network to generate a classification model, wherein the pre-processing may include windowing to cut the labeled speech imagination biosignals in phoneme units, and the learning may include labeling phoneme information for the feature vectors extracted in phoneme units.

In a program stored in a recording medium for learning an artificial neural network based on speech imagination biosignals and phoneme information according to one embodiment of the disclosure, the program may cause, when executed on a computer, the computer to perform the operations of: collecting speech imagination biosignals; labeling the collected speech imagination biosignals with phoneme information; pre-processing the labeled speech imagination biosignals; extracting feature vectors of the pre-processed speech imagination biosignals; and learning the extracted feature vectors through an artificial neural network to generate a classification model, wherein the pre-processing may include windowing to cut the labeled speech imagination biosignals in phoneme units, and the learning may include labeling phoneme information for the feature vectors extracted in phoneme units.

The present disclosure processes phoneme information without distinguishing languages, synthesizes the user's intention to speech into a voice of the form translated into a language desired by the user, thereby enabling communication of a high degree of freedom.

The present disclosure enables multilingual processing by simply reconstructing the user's imagined speech sound from the speech imagination biosignals through a phoneme-unit learning. This can be used in a brain-computer interface-based communication system.

The present disclosure can simultaneously learn multiple languages based on the user's biosignals and phoneme information, and can reconstruct new words, sentences and the like, which have not been learned, based on phoneme-unit learning.

The present disclosure enables multilingual communication rather than a single language by synthesizing the user's intention to speech into a voice of the form translated into a target language desired by the user. That is, the present disclosure can be used as a communication system having a high degree of freedom without restrictions on various sentences and languages.

Meanwhile, the technical effects of the present disclosure are not limited to those mentioned above, and other effects not mentioned can be clearly understood by those skilled in the art from the description below.

### BRIEF DESCRIPTION OF THE DRAWINGS

FIG. 1 is a configuration diagram of a device for learning an artificial neural network according to one embodiment.

FIG. 2 is a flow chart of the operations performed by the device for learning an artificial neural network according to one embodiment.

FIG. 3 is a configuration diagram of a learning device for performing multilingual translation and voice synthesis using speech imagination biosignals according to one embodiment.

FIG. 4 is a configuration diagram of an inference device for performing multilingual translation and voice synthesis using speech imagination biosignals according to one embodiment.

### DETAILED DESCRIPTION OF THE DISCLOSURE

Details regarding the purpose and technical configuration of the present disclosure and the acting effects thereof will be more clearly understood by the following detailed description based on the drawings attached to the specification of the present disclosure. The embodiments according to the present disclosure will be described in detail with reference to the attached drawings.

The embodiments disclosed in this specification should not be construed or used as limiting the scope of the present disclosure. It will be apparent to those skilled in the art that the description including the embodiments of the present specification has various applications. Accordingly, any of the embodiments described in the detailed description of the present disclosure are exemplary for better explaining the present disclosure and are not intended to limit the scope of the present disclosure to the embodiments.

The functional blocks shown in the drawings and described below are merely examples of possible implementations. In other implementations, other functional blocks may be used without departing from the spirit and scope of the detailed description. In addition, although one or more functional blocks of the present disclosure are shown as individual blocks, one or more of the functional blocks of the present disclosure may be a combination of various hardware and software configurations that perform the same function.

In addition, the expression of including certain components is an expression of “open” and simply refers to the presence of the corresponding components, and should not be understood as excluding additional components.

Furthermore, when a component is referred to as being “connected to” or “coupled to” another component, it should be understood that it may be directly connected or coupled to the other component, but that other components may also be present therebetween.

Hereinafter, various embodiments of the present disclosure are described with reference to the attached drawings. However, this is not intended to limit the present disclosure to a specific embodiment, and should be understood to encompass various modifications, equivalents, and/or alternatives of the embodiments of the present disclosure.

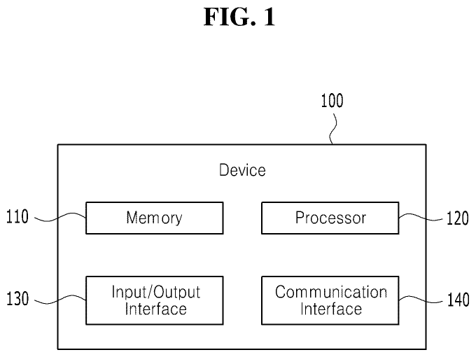

FIG. 1 is a configuration diagram of a device 100 (hereinafter referred to as ‘device 100’) for learning an artificial neural network according to one embodiment.

Referring to FIG. 1, the device 100 according to one embodiment may comprise a memory 110, a processor 120, an input/output interface 130 and a communication interface 140.

The memory 110 may store data acquired from an external device or data generated by itself. The memory 110 may store instructions that cause the processor 120 to operate. For example, the memory 110 can store collected speech imagination biosignals, labeled speech imagination biosignals, pre-processed speech imagination biosignals, extracted feature vectors, phoneme sequence vectors, audio signals, etc.

The processor 120 is a computational device that controls overall operations. The processor 120 can execute instructions stored in the memory 110. The operations of the device 100 according to the embodiment of the present disclosure can be understood as operations performed by the processor 120.

The input/output interface 130 can include a hardware interface or a software interface that inputs or outputs information.

The communication interface 140 allows information to be transceived through a communication network. To this end, the communication interface 140 can include a wireless communication module or a wired communication module.

The device 100 can be implemented as various types of devices that can perform operations through the processor 120 and transceiver information through a network. For example, it can be implemented in the form of a server, a computer device, a portable communication device, a smart phone, a portable multimedia device, a laptop, a tablet PC, etc., but it is not limited to these examples.

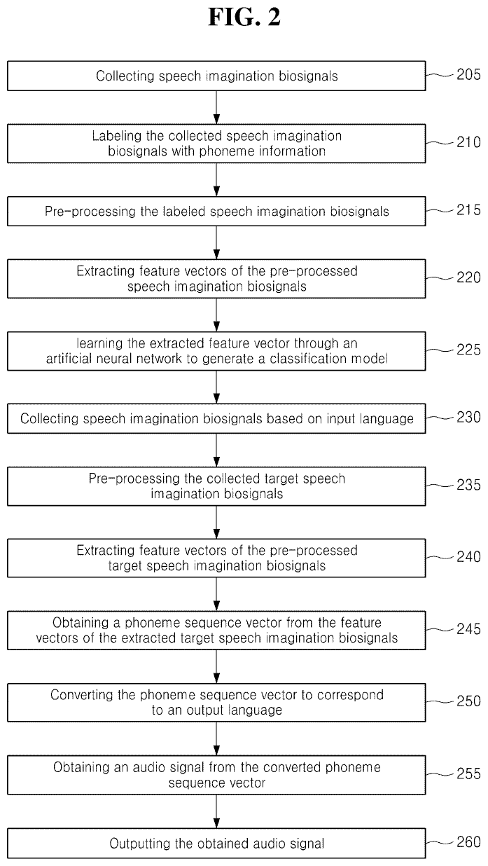

FIG. 2 is a flowchart of operations performed by the device 100 according to an embodiment of FIG. 2. The operations of the device 100 according to the embodiment of FIG. 2 can be understood as operations performed by a processor 120.

Each step disclosed in FIG. 2 is only steps according to a preferred embodiment for achieving the purpose of the present disclosure, and some steps may be added or deleted as needed, and one step may be included and performed in another step. The order of each operation described in FIG. 2 is only an order arranged for the convenience of understanding, and this order is not limited to a time-series order, and the order may be changed and operated differently.

In step 205, the device 100 can collect speech imagination biosignals. The speech imagination biosignals may include an electroencephalogram. The collected speech imagination biosignals may be stored in a predetermined database.

In step 210, the device 100 may label the collected speech imagination biosignals with phoneme information. For example, a database containing speech sounds of words or sentences in various languages such as Korean and English and their corresponding text and phoneme information may be utilized to label the biosignals with phoneme information.

In step 215, the device 100 may pre-process the labeled speech imagination biosignals. The pre-processing may include windowing that cuts the labeled speech imagination biosignals in phoneme units. The windowing may be performed so that adjacent windows at least partially overlap each other. The pre-processing may further include frequency-filtering the labeled speech imagination biosignals.

In step 220, the device 100 can extract feature vectors of the pre-processed speech imagination biosignals. This can be performed based on deep learning and machine learning modules by considering time, space, frequency domain, etc. in order to maximize the distinction of phoneme information of the biosignals.

In step 225, the device 100 can generate a classification model by learning the extracted feature vectors through an artificial neural network. The learning can include labeling the phoneme information for the feature vectors extracted in phoneme units. The learning can be performed for one or more languages.

In step 230, the device 100 can collect speech imagination biosignals based on an input language. The speech imagination biosignals collected in the step 230 may be referred to as target speech imagination biosignals in order to distinguish it from the speech imagination biosignals collected in the step 205.

In step 235, the device 100 can pre-process the collected target speech imagination biosignals. The pre-processing in the step 235 can sequentially perform windowing for all biosignals by overlapping them by a predetermined ratio based on a predetermined window size because labels for the speech imagination biosignals are not given, unlike the pre-processing in the step 215.

In step 240, the device 100 can extract feature vectors of the pre-processed target speech imagination biosignals. For example, the features can be extracted based on deep learning and machine learning modules by considering time, space, frequency domain, etc.

In step 245, the device 100 can obtain phoneme sequence vectors from the feature vectors of the extracted target speech imagination biosignals through the classification model.

In step 250, the device 100 can convert the phoneme sequence vectors to correspond to an output language through a pre-learned translation model. The output language is a language that is outputted as a voice for the speech imagination intended by the user.

In step 255, the device 100 can obtain an audio signal from the converted phoneme sequence vectors through the text-to-speech model. In various embodiments of the present disclosure, the audio signal can be obtained directly from the phoneme sequence vectors obtained in the step 245 without the conversion in the step 250.

In step 260, the device 100 may output the obtained audio signal. This can be performed by a speaker, earphone, headphone or the like.

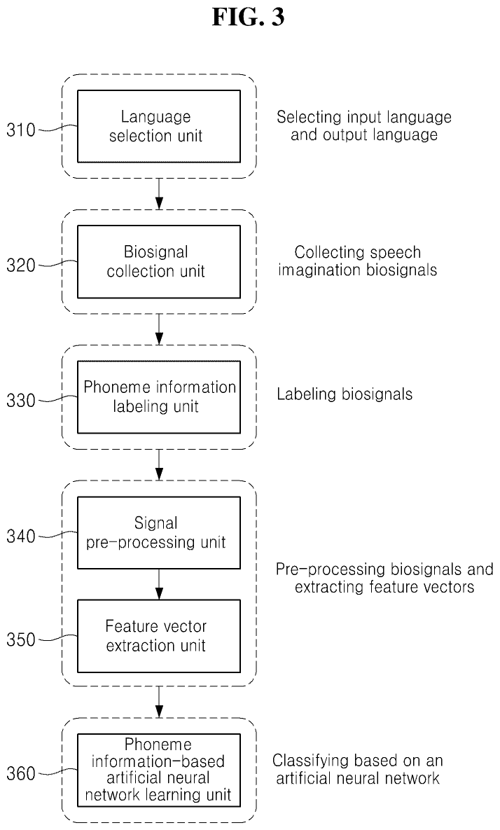

FIG. 3 shows a configuration diagram of a learning device for performing multilingual translation and voice synthesis using speech imagination biosignals according to one embodiment.

Referring to FIG. 3, the device 100 according to one embodiment can include a language selection unit 310, a biosignal collection unit 320, a phoneme information labeling unit 330, a signal pre-processing unit 340, a feature vector extraction unit 350, and a phoneme information-based artificial neural network learning unit 360.

The language selection unit 310 can receive the user's selection of input language and output language. The language selection unit 310 can have a form such as a touch screen (display), a keyboard, or a mouse. The language selection unit 310 can output a language code corresponding to each of the selected input language and output language.

The biosignal collection unit 320 can collect the user's speech imagination biosignals. The speech imagination biosignals may include, for example, electroencephalogram and/or electromyogram. For example, during speech imagination, each brain signal for language-specific phoneme, syllable, word, sentence or the like can be collected. The biosignal collection unit 320 may first construct a presentation text of words or sentences, etc. so that all phonemes of various languages such as Korean and English are included and then present it to the user. For example, the English word, car (/k aa r/), the Korean word, [symbol] (/s a k w a/), the English sentence, Hey Google (/hh ey g uw g ah l/), the Korean sentence, [symbol] (/a n n j v η h a s e j o/) or the like may be configured as a presentation text. The biosignal collection unit 320 can induce various speech imaginations to collect biosignal data corresponding to the relevant presentation text. The biosignal collection unit 320 can provide the presentation text displayed on the screen to the user as an auditory or visual cue. Accordingly, if the user performs the speech imagination, the biosignal collection unit 320 can measure the biosignals (e.g. brain waves) of the relevant section, and the measured data can be stored in a designated database (storage unit).

The phoneme information labeling unit 330 labels (matches) the phoneme information to the biosignals by utilizing a database containing the speech voices of words or sentences in various languages such as Korean and English and their corresponding text and phoneme information. For example, after reading the text information of words and sentences and the time length of the speech data from the database, the time alignment of the biosignals and the text corresponding to the biosignals can be made, and then the phoneme information appropriate for each time section of the biosignals can be labeled. In various embodiments of the present disclosure, the phoneme information may correspond to words or sentences, etc. and include multiple phonemes. In various embodiments of the present disclosure, since the speech imagination brain signals are collected rather than the biosignals collected during actual speech, there is no speech voice signal corresponding to the brain signal. This is distinguished from the method of labeling each section of the biosignals using voice data synchronized with the biosignals.

The signal pre-processing unit 340 can pre-process the detected biosignals into an appropriate frequency domain in order to minimize the noise of the detected biosignals and make subsequent feature extraction clear and easy. This is possible by applying one or more band filters. In addition, a windowing technique that cuts the biosignals in phoneme units can be applied. This is to window the biosignals based on the time alignment information estimated in the previous process. The window size used at this time can be about 20 to 40 ms corresponding to the phoneme length, and the biosignal section can be cut so that the window overlaps the front, back, and middle of the phoneme section by half of the length of the window size.

The feature vector extraction unit 350 extracts vectors containing phoneme information from the collected brain waves. For example, in order to maximize the distinction of phoneme information of the windowed biosignals, the features can be extracted based on deep learning and machine learning modules by considering time, space, and frequency domains. At this time, various feature extraction techniques can be used. For example, a technique for extracting features in the time domain such as a Root Mean Square (RMS) or a technique for extracting features in the space domain such as Common Spatial Pattern (CSP) or log variance can be used.

The phoneme information based artificial neural network learning unit 360 can generate a classification model based on an artificial neural network. The classification model can be learned in phoneme units without distinguishing languages from biosignals converted into vectors. Since the same pronunciation in different languages can be considered as the same phoneme, a multilingual communication method and system can be configured by giving phoneme information on each biosignal windowed in phoneme units as a label and learning the model without distinguishing the languages. To this end, it is possible to analyze and classify feature patterns using a model based on an artificial neural network such as a convolutional neural network (CNN), a recurrent neural network (RNN), a long short-term memory (LSTM), a gated recurrent unit (GRU) or a transformer.

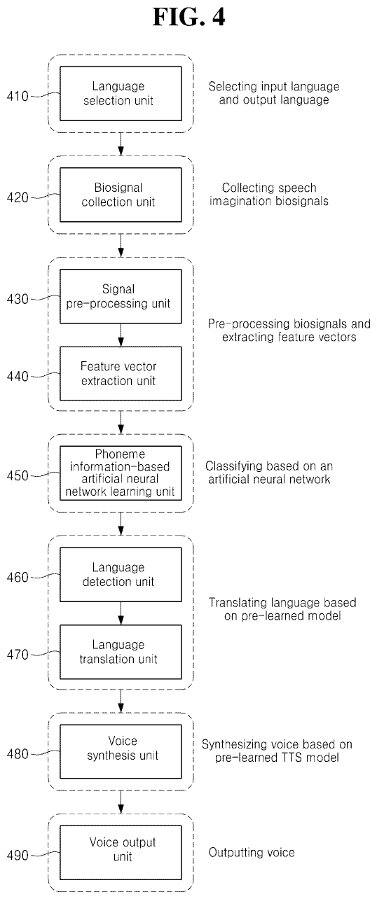

FIG. 4 shows a configuration diagram of an inference device for performing multilingual translation and voice synthesis using speech imagination biosignals according to one embodiment.

Referring to FIG. 4, the device 100 according to one embodiment may include a language selection unit 410, a biosignal collection unit 420, a signal pre-processing unit 430, a feature vector extraction unit 440, a phoneme information-based artificial neural network inference unit 450, a language detection unit 460, a language translation unit 470, a voice synthesis unit 480 and a voice output unit 490. In the configuration of FIG. 4, a unit having the same name as the configuration of FIG. 3 may have at least some of the same functions and roles as the unit of FIG. 3.

The language selection unit 410 may receive a user's selection of an input language and/or an output language. The language selection unit 410 may have a form such as a touch screen (display), a keyboard or a mouse. Each of the selected input language and/or output language is outputted as a language code corresponding to the relevant language. The input language code and the output language code may be entered together as input values of the language translation unit 470. The selection of the output language is a mandatory step that the user must perform, and the selection of the input language may be optional. If the selection of the input language is not performed, the language detection unit 460 may go through a process of identifying the input language through a pre-learned model.

The biosignal collection unit 420 can collect biosignals while speech-imagining a word or sentence intended by the user. In various embodiments of the present disclosure, the biosignals collected to obtain a phoneme sequence vector through a classification model in the inference device (process) may be referred to as target biosignals or target speech imagination biosignals. The biosignal collection unit 420 can measure brain waves generated while imagining the corresponding sound when phonemes, syllables, words, sentences, etc. are visually or audibly presented through a display or speaker, convert them into digital signals, and store them in memory.

The signal pre-processing unit 430 can pre-process the detected biosignals into an appropriate frequency domain in order to minimize the noise of the biosignals and make subsequent feature extraction clear and easy. In addition, a windowing technique that cuts the biosignals in phoneme units can be applied. In the inference process, the label for the speech imagination biosignals is not given unlike the learning process, and the windowing can be performed from the beginning to the end of the biosignals with a 50% overlap on the basis of the window size used for learning.

The feature vector extraction unit 440 can extract the features based on deep learning and machine learning modules by considering time, space and frequency domain, etc. to thereby maximize the distinction of phoneme information of the windowed biosignals. At this time, various feature extraction techniques can be used. For example, techniques such as a Root Mean Square (RMS) for extracting features in the time domain or techniques such as a Common Spatial Pattern (CSP) or log variance for extracting features in the space domain can be used.

The phoneme information based artificial neural network inference unit 450 can perform an inference using the artificial neural network that has completed a learning in the phoneme information based artificial neural network learning unit during the learning process. A phoneme information can be inferred sequentially for the biosignal section that has been windowed by overlapping from the beginning to the end. By considering only k pieces of estimated phoneme information in order (e.g., k=3 or 5), it is possible to re-infer a phoneme label that is most likely to correspond to the relevant section based on repeated phoneme information among the k phonemes. For example, when k=3 and the inferred phoneme information is /n/ /n/ /m/, the phoneme information/n/appeared most frequently in the relevant section can be re-inferred. This process can be sequentially performed from the beginning to the end of the phoneme information corresponding to the biosignals. Finally, among the re-inferred phoneme information, the repeated phoneme values can be deleted to remove the overlapping section, and the phoneme sequence can be finally output. Each voice sequence may correspond to a word or sentence.

The model of the language detection unit 460 may be one that has been pre-learned and can be used when there is no user selection input for the input language in the language selection unit 410. The vector with the previously inferred phoneme information is combined to match a sequence in units of words or sentences and is inputted to the model of the language detection unit 460 in the form of a phoneme sequence such as a token or embedding layer. At this time, a pre-learned artificial neural network-based model may be used. When the input language identification is completed, the model of the language detection unit 460 may generate an input language code and output it.

The model of the language translation unit 470 may be one that has been pre-learned and receives a phoneme sequence vector, an input language code and an output language code. This model may be a pre-learned artificial neural network-based translation model. In this model, a process of converting the inputted phoneme sequence vector so as to match the output language selected by the user may be performed.

The voice synthesis unit 480 can perform voice synthesis based on the pre-learned TTS model. The phoneme sequence of the unit of words, sentences, etc. that have passed through the translation model can be enter as an input of the pre-learned TTS model. The TTS model used at this time may correspond to Tacotron, GPT, etc. The TTS model can output an audio signal converted into a voice. The TTS model can also include a function that can control various aspects of the voice such as pronunciation, stress, voice tone, and emotion, and can generate voices with various styles and characteristics so as to match the purpose using this function.

The voice output unit 490 may provide the voice, which has been synthesized by the voice synthesis unit, audibly to the user through a speaker, headphone or the like. The audio signal outputted from the voice synthesis unit 480 can be transmitted to another system or device (server) rather than the voice output unit 490.

In the present disclosure, precisely recognizing and analyzing phoneme information from biosignals can greatly increase the accuracy and efficiency of multilingual communication, and it allows words, sentences, etc. outside the learning class to be reconstructed through the phoneme information learning of the model.

Various embodiments of the present disclosure can help patients who have lost the ability to speak or have difficulty communicating due to a stroke, a paralysis, etc., as an assistive technology in terms of communication through brain-computer interface technology. Furthermore, it can provide efficiency and convenience in communication in daily life by enabling to express opinions to ordinary people with just thoughts. It also enables communication with people of various nationalities and various languages, and can be utilized as an intuitive and convenient communication technology in various aspects such as language education.

Various embodiments of this disclosure and terms used therein are not intended to limit the technical features described in the present disclosure to specific embodiments, and should be understood to encompass various modifications, equivalents, or substitutes of the embodiments. In connection with the description of the drawings, similar reference numerals may be used for similar or related components. The singular form of a noun corresponding to an item may include one or more items, unless the relevant context clearly indicates otherwise.

In the disclosure, each of the phrases “A or B,” “at least one of A and B,” “at least one of A or B,” “A, B, or C,” “at least one of A, B, and C,” and “at least one of A, B, or C” can encompass all possible combinations of the items listed together with the relevant phrase of the phrases. Terms such as “1,” “2,” or “first” or “second” can be used merely to distinguish one relevant component from another relevant component and do not limit the relevant components in any other respect (e.g., importance or order). When a component (e.g., a first component) is referred to as “coupled” or “connected” to another component (e.g., a second component), with or without the terms “functionally” or “communicatively,” it means that a component may be connected to the other component directly (e.g., by wire), wirelessly, or through a third component.

The term “module” used in the present disclosure may include a unit implemented in hardware, software or firmware, and may be used interchangeably with terms such as logic, logic block, component or circuit. The module may be a component that is configured integrally or a minimum unit of a component that performs one or more functions or a part thereof. For example, according to one embodiment, the module may be implemented in the form of an application-specific integrated circuit (ASIC).

Various embodiments of the present disclosure may be implemented by software (e.g., the program) containing one or more instructions stored in a storage medium (e.g., memory) readable by a machine (e.g., electronic device). The storage medium may include a random access memory (RAM), a memory buffer, a hard drive, a database, an erasable programmable read-only memory (EPROM), an electrically erasable read-only memory (EEPROM), a read-only memory (ROM), and/or the like.

In addition, a processor in the embodiments of the present disclosure may call at least one of one or more instructions stored in a storage medium and execute it. This enables the machine to operate to perform at least one function based on at least one called instructions. The one or more instructions may include code generated by a compiler or code executable by an interpreter. The processor may be a general-purpose processor, a Field Programmable Gate Array (FPGA), an Application Specific Integrated Circuit (ASIC), a Digital Signal Processor (DSP), and/or the like.

The machine-readable storage medium may be provided in the form of non-transitory storage medium. The term “non-transitory”, as used herein, means that the storage medium is a tangible device, but does not include a signal (e.g., an electromagnetic wave). The term “non-transitory” does not distinguish between a case where the data is permanently stored in the storage medium and a case where the data is temporally stored in the storage medium.

The methods according to various embodiments of the present disclosure may be provided as included in a computer program product. The computer program product may be traded between a seller and a buyer as a product. The computer program product may be distributed in the form of machine-readable storage medium (e.g., a compact disc read only memory (CD-ROM)) or may be directly distributed (e.g., download or upload) online through an application store (e.g., Play Store) or between two user devices (e.g., smartphones). In the case of online distribution, at least a portion of the computer program product may be at least temporarily stored or provisionally generated in a machine-readable storage medium such as a manufacturer's server, an application store's server, or a memory of server.

According to various embodiments, each of the components described (e.g., module or program) may include a single or multiple entities. According to various embodiments, one or more of the components or operations of the aforementioned components may be omitted, or one or more other components or operations may be added. Alternatively or additionally, a plurality of components (e.g., module or program) may be integrated into a single component. In such a case, the integrated component may perform one or more functions of each of the plurality of components identically or similarly to those performed by the corresponding component of the plurality of components prior to integration. According to various embodiments, the operations performed by a module, program, or other component may be performed sequentially, in parallel, repeatedly, or heuristically, or one or more of the operations may be performed in a different order, omitted, or one or more other operations may be added.

The claims:

1. A method for learning an artificial neural network based on speech imagination biosignals and phoneme information according to one embodiment of the present disclosure may comprise the steps of:
collecting speech imagination biosignals;
labeling the collected speech imagination biosignals with phoneme information;
Pre-processing the labeled speech imagination biosignals;
extracting feature vectors of the pre-processed speech imagination biosignals; and
learning the extracted feature vectors through an artificial neural network to generate a classification model,
wherein the pre-processing includes windowing to cut the labeled speech imagination biosignals in phoneme units, and the learning includes labeling a phoneme information for the feature vectors extracted in phoneme units.

2. The method according to claim 1, further comprising the steps of:
collecting target speech imagination biosignals;
pre-processing the collected target speech imagination biosignals;
extracting feature vectors of the pre-processed target speech imagination biosignals;
obtaining a phoneme sequence vector from the feature vectors of the extracted target speech imagination biosignals through the classification model; and
obtaining an audio signal from the phoneme sequence vector through a text-to-speech model.

3. The method according to claim 1, further comprising the steps of:
storing target speech imagination biosignals based an input language;
pre-processing the collected target speech imagination biosignals;
extracting feature vectors of the pre-processed target speech imagination biosignals;
obtaining a phoneme sequence vector from the feature vectors of the extracted target speech imagination biosignals through the classification model;
converting the phoneme sequence vector to correspond to an output language through a pre-learned translation model; and
obtaining an audio signal from the phoneme sequence vector through a text-to-speech model.

4. The method according to claim 1, wherein the speech imagination biosignals are an electroencephalogram.

5. The method according to claim 1, further comprising the step of storing the speech imagination biosignals.

6. The method according to claim 1, wherein the pre-processing further includes frequency-filtering the labeled speech imagination biosignals.

7. The method according to claim 1, wherein the windowing is performed so that adjacent windows at least partially overlap each other.

8. The method according to claim 1, wherein the learning is performed for one or more languages.

9. A device for learning an artificial neural network based on speech imagination biosignals and phoneme information comprising:
a biosignal collection unit for collecting speech imagination biosignals;
a phoneme information labeling unit for labelling the collected speech imagination biosignals with phoneme information;
a signal pre-processing unit for pre-processing the labeled speech imagination biosignals;
a feature vector extraction unit for extracting feature vectors of the pre-processed speech imagination biosignals; and
an artificial neural network learning unit for learning the extracted feature vectors through an artificial neural network to generate a classification model,
wherein the pre-processing may include windowing to cut the labeled speech imagination biosignals in phoneme units, and the learning may include labeling phoneme information for the feature vectors extracted in phoneme units.

10. A program stored in a recording medium for learning an artificial neural network based on speech imagination biosignals and phoneme information, wherein the program may cause, when executed on a computer, the computer to perform the operations of:
collecting speech imagination biosignals;
labeling the collected speech imagination biosignals with phoneme information;
pre-processing the labeled speech imagination biosignals;
extracting feature vectors of the pre-processed speech imagination biosignals; and
learning the extracted feature vectors through an artificial neural network to generate a classification model,
wherein the pre-processing may include windowing to cut the labeled speech imagination biosignals in phoneme units, and the learning includes labeling phoneme information for the feature vectors extracted in phoneme units.
